(19) United States
(12) Patent Application Publication
(10) Pub. No.: US 2007/0076369 A1
(43) Pub. Date: Apr. 5, 2007

(54) Method of determining minimal dimension of computer and computer designed though the method

(75) Inventors: Yueh-Yun Chen, Taipei City (TW); Shen-Chang Tsao, Taipei City (TW)

Correspondence Address: BIRCH STEWART KOLASCH & BIRCH, PO BOX 747, FALLS CHURCH, VA, 22040-0747, US

(73) Assignee: FIRST INTERNATIONAL COMPUTER, INC.

(21) Appl. No.: 11/407,958

(22) Filed: Apr. 21, 2006

(30) Foreign Application Priority Data
Sep. 30, 2005 (TW) 094134283

(51) Int. Cl. G06F 1/20

(52) U.S. Cl. 361/687

(57) ABSTRACT

A method to determine the minimal dimension of a personal computer and a personal computer constructed through the method are provided An optical disc driver and a heat dissipater are laid aside to define a length and a width of the computer. Then, define the size of a motherboard according to the length and width. The highest electronic component allocated on the motherboard and the optical disc driver are stacked up to define a height. Allocate electronic components on the motherboard and arranging the motherboard, optical disc driver and heat dissipater into a casing with the length, width and height to obtain the minimal dimension of the computer.

### CROSS-REFERENCE TO RELATED APPLICATIONS

This non-provisional application claims priority under 35 U.S.C. §119(a) on Patent Application No(s). 094134283 filed in Taiwan, R.O.C. on Sep. 30, 2005, the entire contents of which are hereby incorporated by reference.

### BACKGROUND OF THE INVENTION

1. Field of Invention

The invention generally relates to a method of determining minimal dimensions of a computer, and in particular relates to a method of allocating components and peripheral devices and minimizing the dimensions of a personal computer.

2. Related Art

A conventional desktop computer mainly includes a motherboard, a processor, memories, hard disc, optical disc driver, power supply, peripheral interface, input/output ports, casing and other components. As for the processor, the processor manufacturers, such as INTEL and AMD, develop specific processors (such as INTEL Corporation's Pentium processors and the Pentium-M processors) for desktop computers and notebook computers respectively. The desktop computer manufacturers then construct the motherboards with suitable allocations of those electronic components, including processors, north and south bridge chips, memories and so on. The motherboard and other peripheral devices, such as hard disc, optical disc driver, power supply, display interface and network interface, according the specifications of the computer, are then installed in the computer casing. For example, a typical stand type computer casing, such as that disclosed in U.S. Pat. No. 6,382,744 or U.S. Design Pat. No. D473,555, has dimensions around 45 cm depth, 19 cm width and 40 cm height, in which the motherboard stands vertically in the computer casing; the hard disc, optical disc drive and other peripheral devices are also mounted on bearing frames inside the computer casing. Because the computer casing has larger dimensions and can be disassembled, it is advantageous in the future maintenance, upgrade or replacement of internal electronic devices. But this kind of stand type computer casing mostly uses screws to fix the hard disc, optical disc driver, and other peripheral devices, as well as the side covers, to the bearing frames. Therefore, there are many screws in disassembling and assembling that make the disassembly and assembly difficult.

Also, for the majority of computer users, they are not necessary to repair or upgrade the computers. Therefore, the larger computer casing is often unnecessary. So the manufacturers release another kind of desktop computer called Barebone, Mini PC or Small Form Factor (SSF). The Barebone includes motherboard, video card, network card, power supply and interfaces of USB, IEEE1394 etc. in a casing of about 20 cm length, 30 cm width and 23 cm height, such as that disclosed in U.S. Published Patent Nos. 20030016494 and 20050078442. The electronic components and peripheral devices for the Barebone are the same as that of desktop computers but fitted in a smaller computer casing. It has advantages of smaller size and better integration. In accompany with good appearance design such as glassy surface, the Barebone can be placed in a living room or bedroom, and applied with multimedia applications to become a multimedia computer.

However, the Barebone also uses screws to fix the hard disc, optical disc driver and other peripheral devices, as well as the side covers, to the bearing frames and makes the disassembly and assembly difficult.

As a result of technology unceasing development, Notebook computers are competitive to desktop computers in the function and price. Even though the present desktop computer manufacturers have provided Barebone computers, they still have a certain volume. When the function and price of notebook computers are gradually equal to or even better than desktop computers, the portable characteristics of notebook computers make them the first choice of common users. Although the desktop computers are still unceasingly renewed on their central processors (CPU) and operation systems, the larger volume and lacking of other new applications still make the desktop computers difficult to change the trend of being substituted by notebook computers. In order to avoid desktop computers being completely substituted by notebook computers, the manufacturers of desktop computers have to do more on the miniaturization, new appearance, multimedia applications and so on, so as to attract user's attentions.

### SUMMARY OF THE INVENTION

In the conventional desktop computers and the smaller Barebone computers that have only a half of dimensions of typical desktop computers, the electronic components including processors, memories or optical disc drivers are still of the desktop computer specifications and limit the miniaturization possibility of desktop computers. Therefore, the invention provides a desktop computer construction in which the electronic components and peripheral devices are of notebook computer specifications.

A method to determine minimal dimensions of a personal computer and a personal computer constructed through the method according to the invention uses electronic components and peripheral devices of notebook computer specifications. The components and peripheral devices are central processor, memory module, heat dissipater, optical disc driver and so on. The optical disc driver and the heat dissipater laid aside in a plane to define the minimal length and the minimal width of the personal computer. The size of a motherboard does not exceed a minimal area formed by the minimal length and the minimal width. Based on the minimal area, the central processor, north bridge chip, south bridge chip, memory module and input/output ports are allocated on the motherboard. The memory module and the optical disc driver are stacked up to define a minimal height of the computer. The length, width and height are used to decide a casing for containing the motherboard and all the electronic components and peripheral devices. Therefore, a minimal size personal computer is obtained. The casing is composed of a cover and a body. All the electronic components and peripheral devices are arranged in the body. The cover is assembled with the body in a slide manner so as to reduce using screws and make the assembly easier.

A method to determine minimal dimensions of a personal computer and a personal computer constructed through the method according to the invention uses electronic components and peripheral devices of notebook computer specifications. The dimensions of larger components and peripheral devices are considered to determine the volume of computer. The electronic components and peripheral devices are then arranged in the casing. Practically, the dimensions of the personal computer are around 22.6 cm length, 17.2 cm width, and 4.2 cm height, which are about one fifth of conventional stand type desktop computers and about one third of conventional Barebone so as to be the minimal dimensions of personal computer.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The invention will become more fully understood from the detailed description given hereinbelow. However, this description is for purposes of illustration only, and thus is not limitative of the invention, wherein:

FIG. 1 is a flowchart of a method of the invention;

FIG. 2 is a descriptive view of determining the length and width of a computer;

FIG. 3 is a descriptive view of determining the height of a computer;

FIG. 4 is a descriptive view of layout of a motherboard in the invention;

FIG. 5 is an exploded view of a minimized computer of the invention;

FIG. 6 is a perspective view of a casing in the invention;

FIG. 7 is a partial view of a casing in the invention;

FIGS. 8A and 8B are descriptive views of assembling the casing in the invention; and

FIG. 9 is a perspective view of minimized computer of the invention.

### DETAILED DESCRIPTION OF THE INVENTION

The invention provides a method to determine minimal dimensions of a personal computer and a personal computer constructed through the method. The personal computer is a data processing device capable of connecting with peripheral devices, such as monitor, keyboard and mouse, executing specific operations and displaying information on the monitor according to user's commands. In the invention the personal computer uses electronic components and peripheral devices of notebook computer specifications. For example, applying INTEL Pentium-M central processor, double data rate small-outline dual inline memory module (DDR2 SODIUMM), 2.5-inch hard disc, slim type CD-ROM, slim type DVD-ROM or slim type Combo of notebook computer specifications and so on. The functions of the electronic components and peripheral devices are of prior arts and will not be described herein.

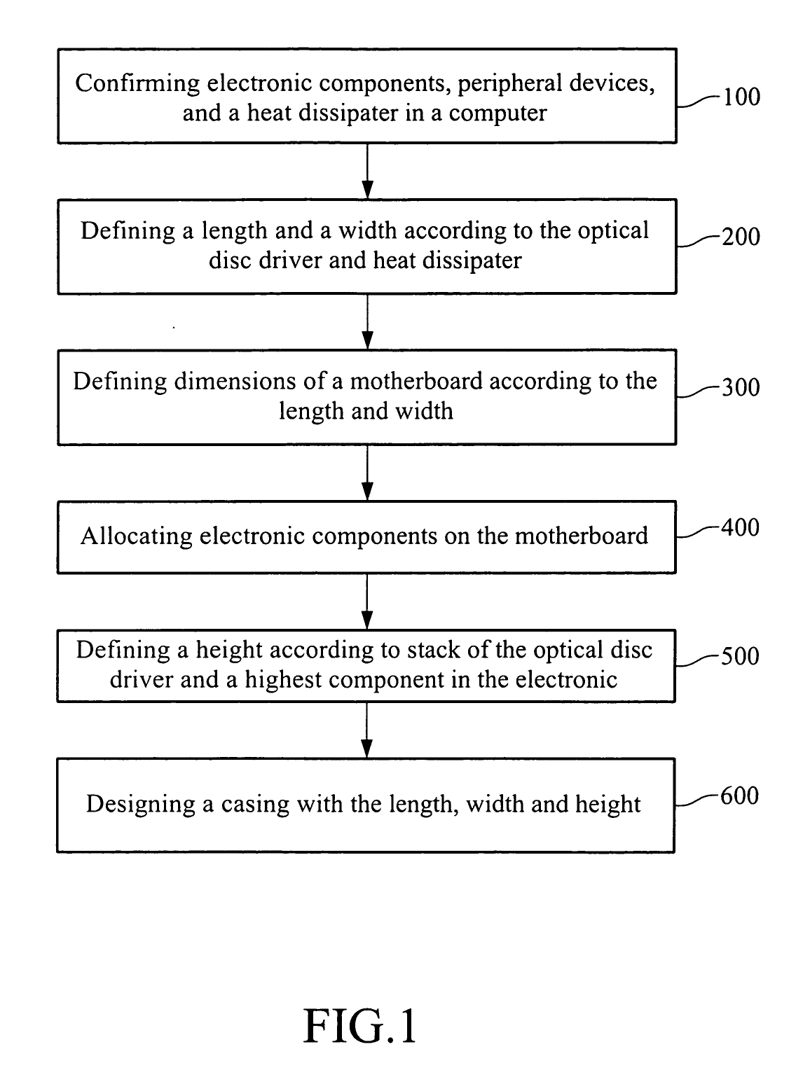

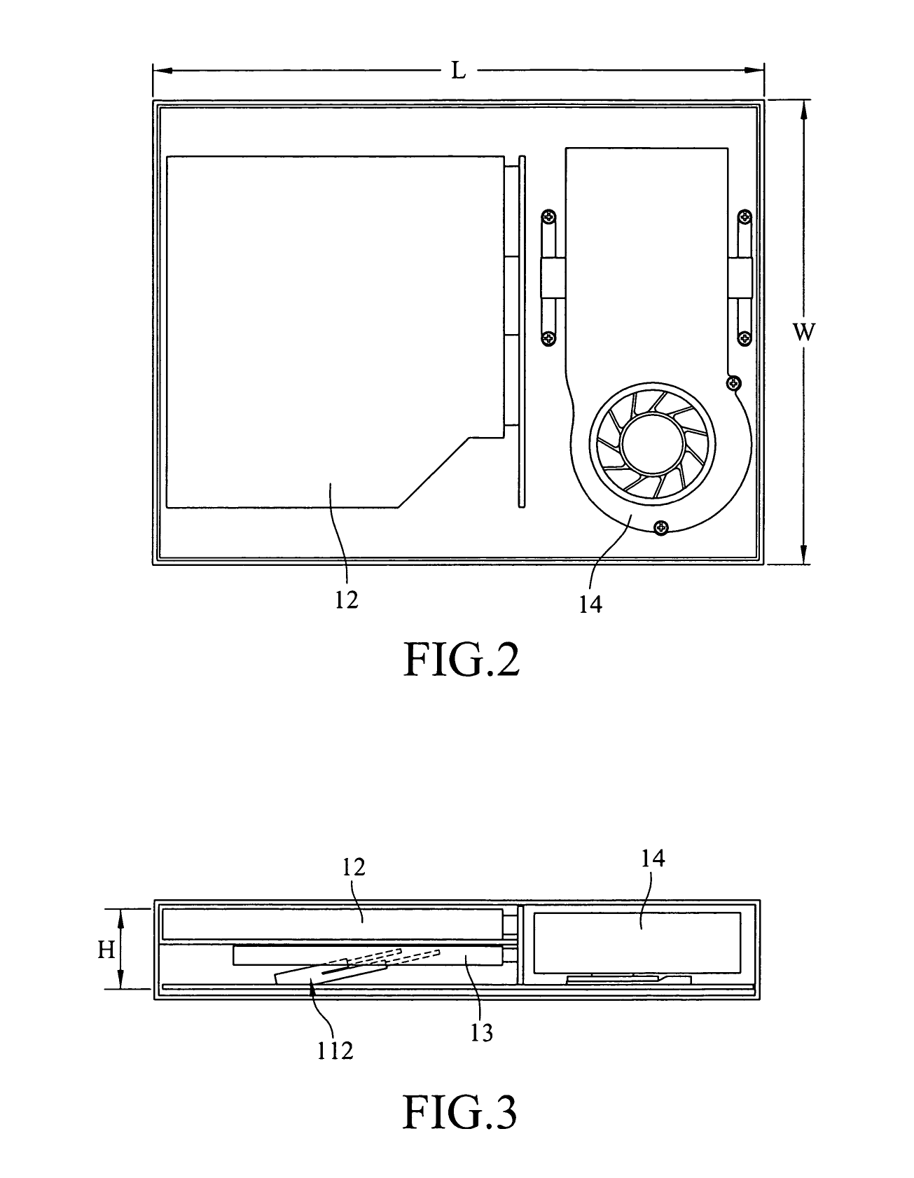

As shown in FIG. 1, a method to determine minimal dimensions of a personal computer according to the invention includes the following steps. First, confirming the electronic components, peripheral devices and heat dissipater to be applied in the computer (step 100). The electronic components includes central processor, north bridge chip, south bridge chip, memory module, video chip, audio chip, peripheral component interconnect (PCI), wireless LAN, local network module and input/output ports, etc. The peripheral devices include hard disc, optical disc driver and so on. The optical disc driver 12 and a heat dissipater 14 are laid aside and defined a length L and a width W (step 200, and referring to FIG. 2). Then, defining the size of a motherboard 11 according to the length L and width W (step 300). Allocating the components, such as central processor, north bridge chip, south bridge chip, memory module, video chip, audio chip, wireless LAN, local network module and input/output ports, in the area of the motherboard (step 400). In the aforesaid electronic components, the central processor is allocated correspondingly to the heat dissipater 14; and the highest electronic component is allocated correspondingly to the optical disc driver. In an embodiment, a memory with two layers of SODIMM slots is used in the invention. The two layers of SODIMM slots of memory modules with inserted memories are mounted on the motherboard and are the highest portion among the electronic components.

Therefore, the memory module 112 and the optical disc driver 12 are stacked up to define a height H (step 500, and referring to FIG. 3). Then, designing a casing with the length L, width W and height H (step 600) for containing all the electronic components and the peripheral devices may be obtained for a minimal size personal computer.

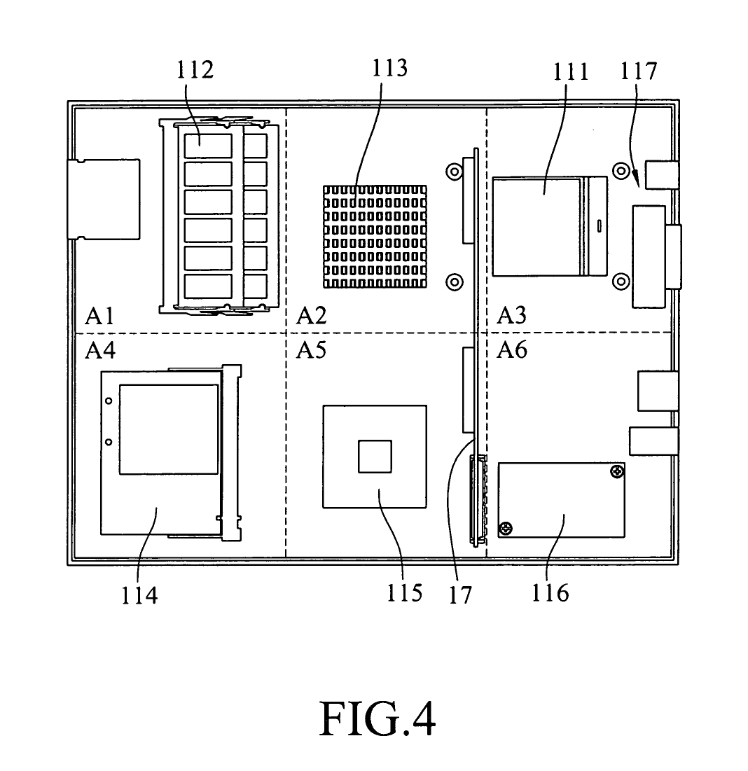

Now referring to FIG. 4, a layout of motherboard in the invention, the motherboard 11 has an area defined in step 200 with an optical disc driver 12 and a heat dissipater 14 laid aside. Within the defined area, electronic components are arranged thereon. The electronic components are allocated on the motherboard 11 in six regions A1, A2, A3, A4, A5 and A6. The memory module 112 is located in region A1. The north bridge chip 113 is located in region A2. The central processor 111 is located in region A3. The mini peripheral component interconnect (mini PCI) 114 is located in region A4. The south bridge chip 115 is located in region A5. The local network module 116 is located in region A6. There are various input/output ports 117 mounted on sides of the regions A3 and A6. There is a connection interface 17 allocated between regions A2 and A5 and A3 and A6. Other electronic components and chips are allocated beside aforesaid major components.

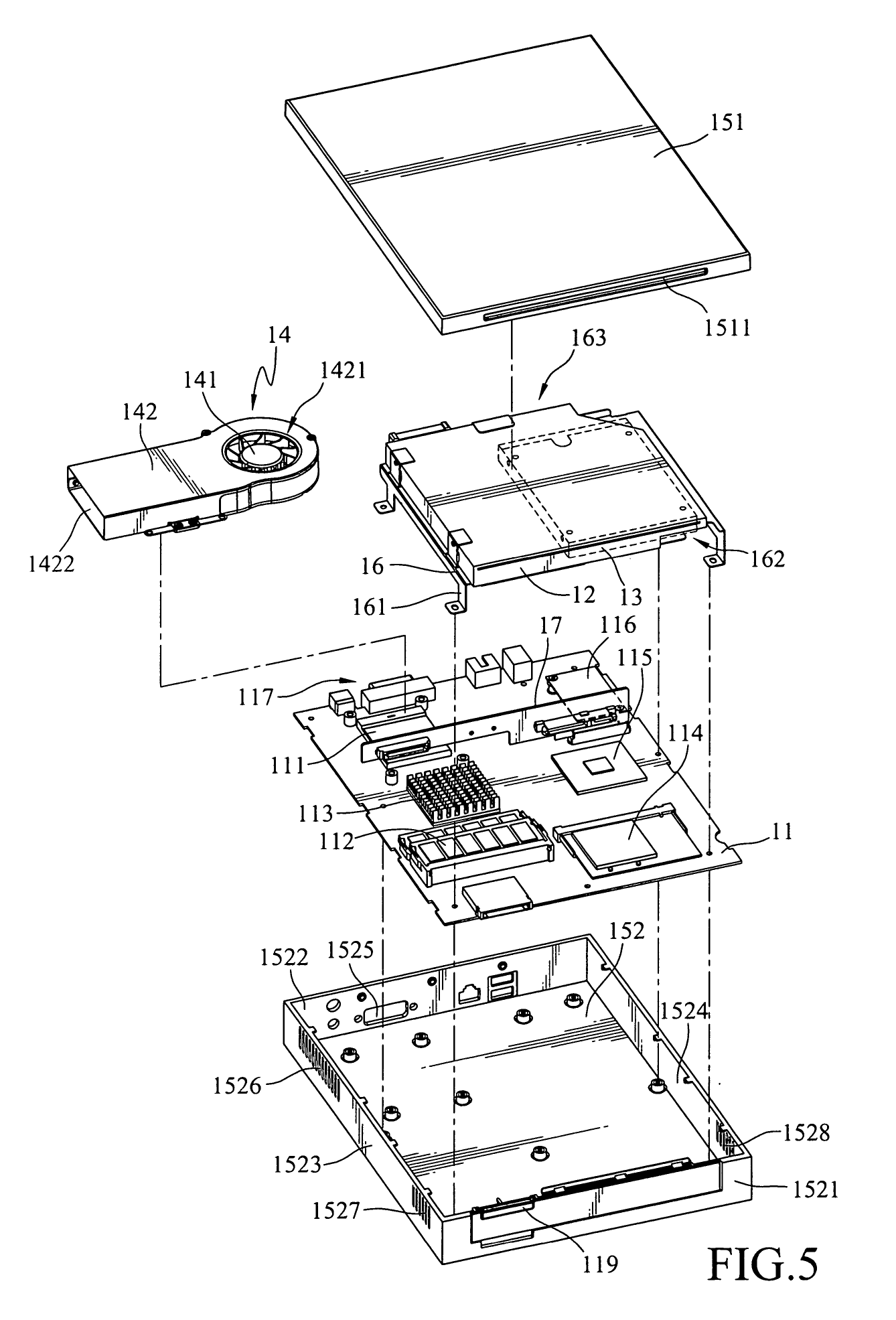

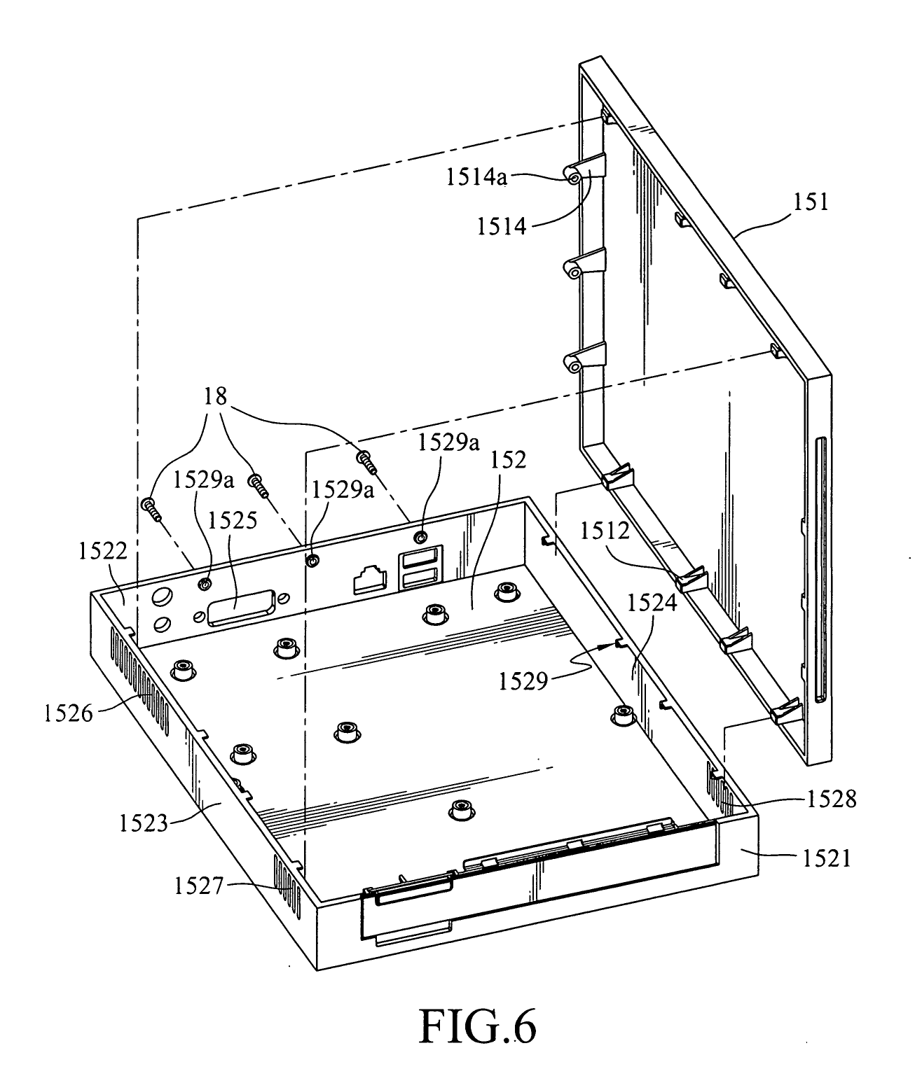

Referring to FIG. 5 and FIG. 6, an exploded view and a casing perspective view in an embodiment of the invention, the personal computer 10 mainly includes at least a motherboard 11, an optical disc driver 12, a hard disc 13, a heat dissipater 14 and a casing 15 (151, 152). The electronic components mounted on the motherboard 11 are allocated as shown in FIG. 4. The heat dissipater 14 includes a centrifugal fan 141 and a duct 142. The heat dissipater 14 is allocated on top of the central processor 111. The duct 142 is made of metal and tightly contacts with the central processor 111. The duct 142 includes at least an air inlet 1421 and an air outlet 1422. The centrifugal fan 141 is allocated in the air inlet 1421 of the duct 142. The heat generated by the central processor 111 is conducted to the duct 142. The centrifugal fan 141 brings air in from the air inlet 1421 and expels through the duct 142 and the air outlet 1422 so that the heat transferred from the central processor 111 to the duct 142 is removed.

Upon the regions A1, A2, A4 and A5 of the motherboard 11, a carrier 16 is mounted. The carrier 16 has a similar area of the regions A1, A2, A4 and A5, and has a plurality of legs 161 to lift the carrier 16 from the motherboard 11 with a suitable height that is larger than the height of the memory module 112. Under the carrier 16, there is a space 162 to hold the hard disc 13. The space 162 is corresponding to the region A4 of the motherboard 11 where the electronic components have less height. The hard disc 13 is fixed in the space 162 and electrically connected to the connection interface 17 vertically mounted on the motherboard 11. On top of the carrier 16, there is a space 163 to hold the optical disc driver 12. The optical disc drive 12 is fixed in the space 163 and electrically connected to the connection interface 17 vertically mounted on the motherboard 11.

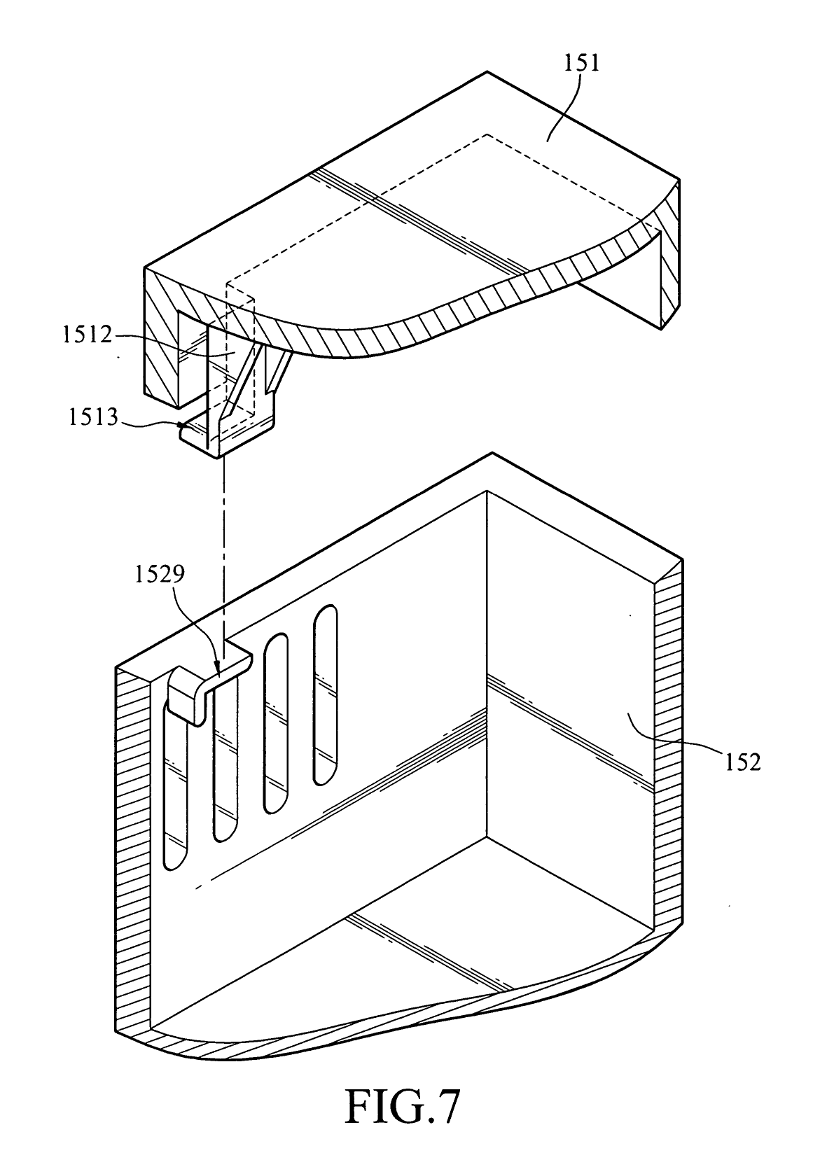

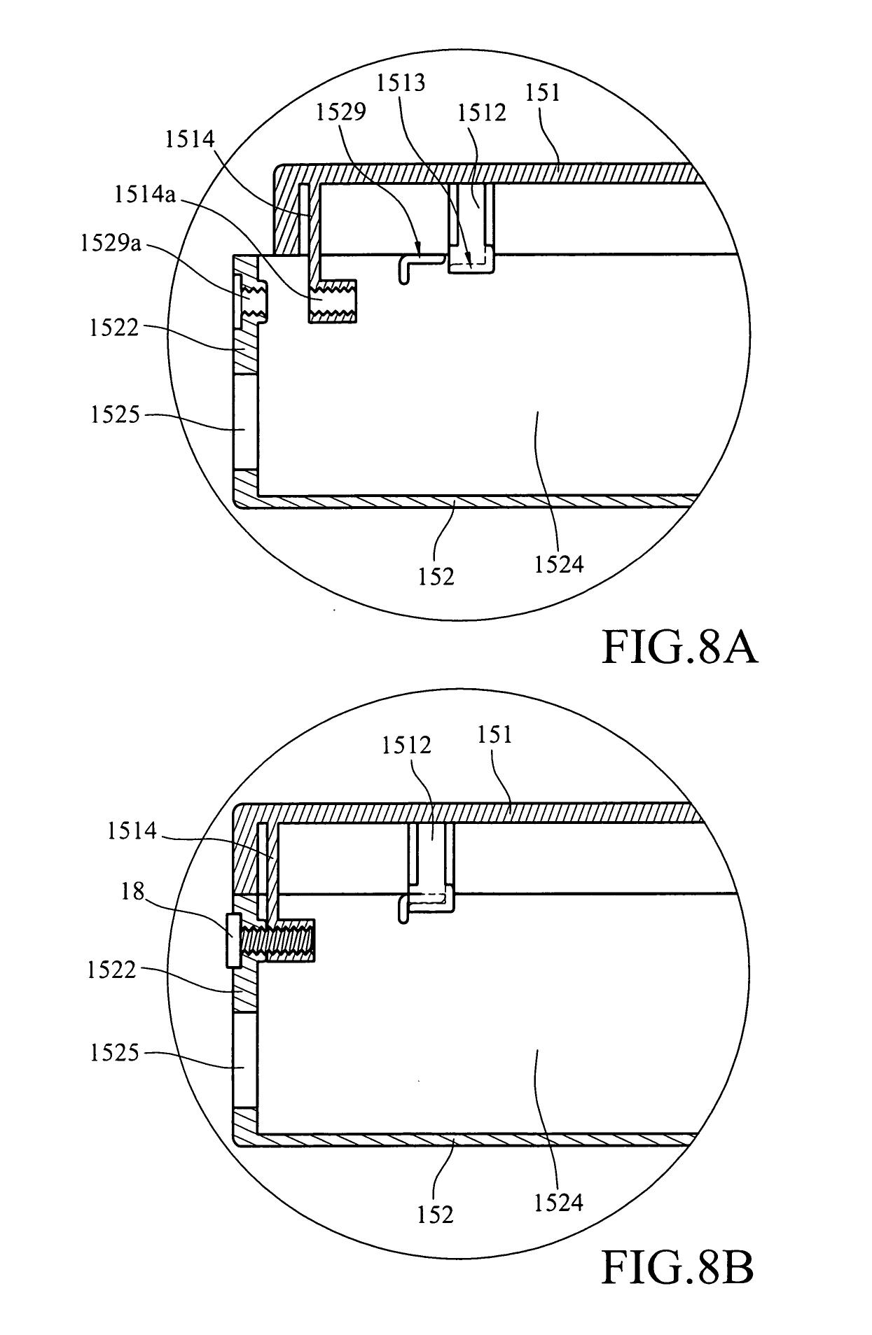

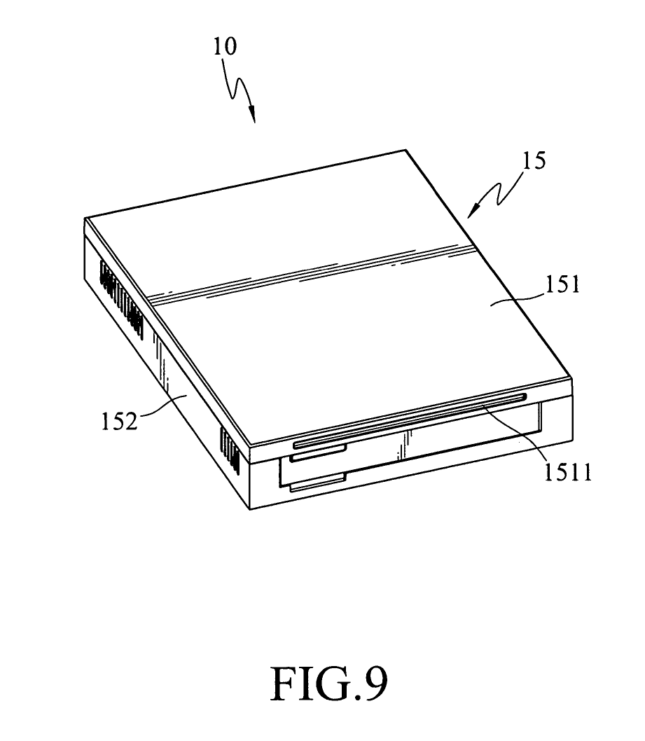

The casing 15 is composed of a cover 151 and a body 152. The body 152 has an area slightly larger than that of the motherboard 11. There are four walls 1521, 1522, 1523 and 1524 formed outside to get a space opening upwards. The first wall 1521 is defined as front of the computer 10 where at least a power button 119 is allocated. The second wall 1522 is defined as back of the computer 10 where a plurality of holes 1525 corresponding to the input/output ports 117 of the motherboard 11 are formed. The third wall 1523 is at least formed with a pair of outlet slots 1526 corresponding to the air outlet 1422 of the heat dissipater 14, and an intake slot 1527 at the other side of the outlet slot 1526. The fourth wall 1524 is also formed with an intake slot 1528 corresponding to the intake slot 1527. The height of the casing 15 (the cover 151 and the body 152) is larger than the total height of the motherboard 11, the memory module 112, and the optical disc driver 12. A disc opening 1511 is formed on the first wall 1521 side (possibly on the cover 151 as shown, on the body 152 or between) and corresponding to the optical disc driver 12 for an unshown optical disc to pass through. The cover 151 and the body 152 are assembled in a slide manner as shown in FIGS. 6, 7, 8A and 8B. There are several hooks 1512 formed on two longitudinal inner sides of the cover 151. The hooks 1512 are L-shaped and having fastening portion 1513 extending outwards at the ends. There are several columns 1514 formed on latitudinal sides of the cover 151. Each column 1514 is formed with a screw hole 1514a. At inner sides of the third wall and fourth walls 1523, 1524 of the body 152, there are holders 1529 corresponding to the hooks 1512. At the second wall 1522 of the body 152, there is at least a hole 1529a corresponding to the column 1514. Please refer to FIGS. 8A, 8B and 9, when assembly, the cover 151 is first placed on the body 152 with a slight offset where the fastening portions 1513 of the hooks 1512 are facing to but away from the holders 1529 of the body 152. Then, moving the cover 151 and the body 152 to the right position where the fastening portions 1513 of the hooks 1512 fit into the holders 1529 so as to limit the back-and-forth or up-and-down movement of the cover 151. In addition, at this position, let the screw hole 1514a of the cover 151 fit with the hole 1529a of the body 152. Therefore, a screw 18 passes through the hole 1529a of the body 152 and the screw hole 1514a of the cover 151 to fasten the cover 151 and the body 152 in position so as to limit the left-and-right movement of the cover 151. Thus the cover 151 is fixed with the body 152.

Further referring to FIGS. 2, 3 and 6, the invention provides a method to determine minimal dimensions of a personal computer and a personal computer constructed through the method. The computer of the invention uses electronic components and peripheral devices of notebook computer specifications. The dimensions of larger components and peripheral devices are considered to determine minimal dimensions of casing. For example, the length and width are determined by the size of an optical disc driver and a heat dissipater in a plane. The height is determined by the height of a memory module and an optical disc driver stacked over. The electronic components and peripheral devices are then arranged in the casing. Practically, the dimensions of the casing are around 22.6 cm length, 17.2 cm width and 4.2 cm height.

For heat dissipation, the computer 10 has intake slots 1527 and 1528 at the body 152 to let air through. Among the electronic components and optical disc driver 12, hard disc 13 on the carrier 16, there is space for airflow to pass through. The cooling air is driven by fan 141 of the heat dissipater 14 from the air inlet 1421, passing through the duct 142 to cool down the central processor 111, and expelled through the air outlet 1422 and the outlet slot 1526. The heat dissipation of the computer 10 is then achieved.

In application, the computer 10 of the invention is not for personal use only. It can be applied to entertainment use, such as home theater. For example, at sides of the regions A3 and A6, the input/output ports 117 may include AV terminals, blue tooth, digital visual interface (DVI), wireless LAN, S-video, Universal Serial Bus (USB) and so on, so that the computer of the invention can receive TV signal from the AV terminals; receive audio signals from an audio device via blue tooth; output video signals via the S-video interfaces to a liquid crystal display (LCD) display of TV, and many other applications.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A method for determining the minimal dimension of a computer, comprising steps of:
confirming electronic components, peripheral devices, at least an optical disc driver, at least a hard disc, and at least a heat dissipater to be included in said computer;
determining a length and a width according to said optical disc driver and said heat dissipater laid aside in a plane;
defining the dimension of a motherboard according to said length and width;
allocating said electronic components on said motherboard;
determining a height according to stack of a highest component in said electronic components and said optical disc driver; and
designing a casing with said length, width, and height for containing said motherboard, electronic components, peripheral devices, optical disc driver, hard disc, and heat dissipater.

2. The method for determining minimal the dimension of a computer according to claim 1 wherein said electronic components, peripheral devices, optical disc driver, and hard disc are of notebook computer specifications.

3. A computer having minimal dimension as claimed in claim 1, comprising at least a central processor, electronic components, a heat dissipater, and an optical disc driver with notebook computer specifications; said central processor and electronic components are mounted on a motherboard; said heat dissipater is corresponding to said central processor; said optical disc driver is corresponding to said electronic components and stacked over a part of said electronic components; said heat dissipater and said optical disc driver are allocated in a plane; and said motherboard, central processor, electronic components, heat dissipater, and optical disc driver are allocated in a casing.

4. The computer having minimal dimension according to claim 3 wherein said a part of electronic components is a memory module, which is the highest one in said electronic components.

5. The computer having minimal dimension according to claim 3 wherein said motherboard has a dimension defined by said heat dissipater and said optical disc driver allocated in a plane.

6. The computer having minimal dimension according to claim 3 wherein said casing has a height slightly larger than that of said optical disc driver stacked over said a part of electronic components.

7. The computer having minimal dimension according to claim 3 wherein said optical disc driver is disposed on a carrier.

8. The computer having minimal dimension according to claim 7 wherein said carrier also holds a hard disc.

9. The computer having minimal dimension according to claim 3 wherein said casing is composed of a body and a cover assembled in a slide manner.

10. The computer having minimal dimension according to claim 9 wherein said cover is formed with a plurality of hooks having fastening portions to be fitted into respective holders formed on said body so as to fix together after said cover and said body being slid in position.

11. The computer having minimal dimensions according to claim 9 wherein said cover is formed with a plurality of columns with screw hole; said body is formed with a plurality of holes corresponding to said screw hole; and at least a screw is used to fix said cover and said body through said hole and said screw hole.
